(19) United States
(12) Patent Application Publication
(10) Pub. No.: US 2025/0277675 A1
(43) Pub. Date: Sep. 4, 2025

(54) METHOD AND DEVICE FOR PLACING ROAD OBJECTS ON MAP USING SENSOR INFORMATION

(71) Applicant: GRABTAXI HOLDINGS PTE. LTD., Singapore (SG)

(72) Inventors: Andrei GEORGESCU, Cluj Napoca (RO); Adrian-Ioan MARGIN, Cluj Napoca (RO); Bogdan-Andrei GLIGA-HAMBET, Cluj Napoca (RO); Zsolt-Francisc VADASZI, Cluj Napoca (RO)

(21) Appl. No.: 18/863,754

(22) PCT Filed: May 23, 2023
(86) PCT No.: PCT/SG2023/050357

§ 371 Date: Nov. 7, 2024

(30) Foreign Application Priority Data
Jun. 20, 2022 (SG) 10202250225G

(51) Int. Cl. G01C 21/00; G06T 7/70; G06V 20/58

(52) U.S. Cl. CPC G01C 21/3811; G01C 21/3841; G01C 21/3848; G06T 7/70; G06V 20/58; G06T 2207/20081; G06T 2207/30244; G06T 2207/30252

(57) ABSTRACT

Aspects concern a method including determining initial map positions of a road object on a map, the initial map positions respectively corresponding to images of the road object that are captured by a camera at different camera positions on the map, and constructing a pose graph in which one or more pairs of the initial map positions are respectively connected by first edges, one or more pairs of the different camera positions are respectively connected by second edges, and the initial map positions are respectively connected to the different camera positions by third edges. The method further includes optimizing the constructed pose graph by adjusting the initial map positions, the different camera positions, the second edges and the third edges so that lengths of the first edges are minimized, and determining a final map position of the road object, based on the optimized pose graph.

### TECHNICAL FIELD

Various aspects of this disclosure relate to methods and devices for placing road objects on a map, using sensor information.

### BACKGROUND

Having an up-to-date map may be useful in a variety of contexts and applications. Automatically detecting road objects from street-level images and placing the detected road objects at right locations of the map may remove a lot of labor-intensive processes.

Most approaches of detecting and placing road objects on a map may involve either custom and/or expensive hardware or costly computing tasks like structure from motion (SFM). Therefore, having a solution that works with cheap hardware like standard mobile phones may enable the detecting and placing of road objects to be more scalable and may also increase a map update frequency.

Typically, to add a new road object to a map, three operations may be required. First, a road object may be detected in image data. Second, a position (a distance and an orientation) of the road object relative to a camera may be found. Third, a geolocation and an orientation of the camera may be found. Assuming such information is known with high accuracy, a geolocation and an orientation of the road object may be found.

### SUMMARY

Various embodiments concern a method for method of placing road objects on a map, using sensor information, the method including determining initial map positions of a road object on the map, the initial map positions respectively corresponding to images of the road object that are captured by a camera at different camera positions on the map, and constructing a pose graph in which one or more pairs of the initial map positions are respectively connected by first edges, one or more pairs of the different camera positions are respectively connected by second edges, and the initial map positions are respectively connected to the different camera positions by third edges. The method further includes optimizing the constructed pose graph by adjusting the initial map positions, the different camera positions, the second edges and the third edges so that lengths of the first edges are minimized, and determining a final map position of the road object, based on the optimized pose graph.

The initial map positions may be represented on the map as areas indicating uncertainties of the initial map positions.

The determining the final map position of the road object may include adding the adjusted initial map positions to determine the final map position respectively connected to the different camera positions by the adjusted third edges.

The final map position may be represented on the map as an area indicating an uncertainty of the final map position.

The method may further include identifying the road object in each of the images, using an object detector.

The method may further include determining relative positions of the identified road object relative to the camera in the images, respectively.

The relative positions of the identified road object relative to the camera may be determined using a deep learning depth estimation.

The positions of the identified road object relative to the camera may be determined by using previously determined parameters such as object physical size, object aspect in camera images and physical properties of the camera.

The method may further include determining an orientation of the camera.

The initial map positions of the road object may be determined based on a position of the camera, the determined orientation of the camera, and the determined relative positions of the identified road object relative to the camera.

A server includes at least one memory storing instructions, and at least one processor configured to execute the stored instructions to determine initial map positions of a road object on the map, the initial map positions respectively corresponding to images of the road object that are captured by a camera at different camera positions on the map, and construct a pose graph in which one or more pairs of the initial map positions are respectively connected by first edges, one or more pairs of the different camera positions are respectively connected by second edges, and the initial map positions are respectively connected to the different camera positions by third edges. The at least one processor is further configured to execute the stored instructions to optimize the constructed pose graph by adjusting the initial map positions, the different camera positions, the second edges and the third edges so that lengths of the first edges are minimized, and determine a final map position of the road object, based on the optimized pose graph.

The initial map positions may be represented on the map as areas indicating uncertainties of the initial map positions.

The at least one processor may be further configured to execute the stored instructions to add the adjusted initial map positions to determine the final map position respectively connected to the different camera positions by the adjusted third edges.

The final map position may be represented on the map as an area indicating an uncertainty of the final map position.

The at least one processor may be further configured to execute the stored instructions to identify the road object in each of the images, using an object detector.

The at least one processor may be further configured to execute the stored instructions to determine relative positions of the identified road object relative to the camera in the images, respectively.

The at least one processor may be further configured to execute the stored instructions to determine an orientation of the camera.

The initial map positions of the road object may be determined based on a position of the camera, the determined orientation of the camera, and the determined relative positions of the identified road object relative to the camera.

A computer program element may include program instructions, which, when executed by one or more processors, cause the one or more processors to perform the method.

A computer-readable medium may include program instructions, which, when executed by one or more processors, cause the one or more processors to perform the method.

### BRIEF DESCRIPTION OF THE DRAWINGS

The invention will be better understood with reference to the detailed description when considered in conjunction with the non-limiting examples and the accompanying drawings, in which:

FIG. 1 shows a diagram of a system for placing road objects on a map, using sensor information, according to embodiments;

FIG. 2 shows a diagram illustrating a reduction of uncertainty by overlapping independent measurements;

FIG. 3 shows a diagram illustrating a propagation of errors through different stages of placing a road object on a map, according to embodiments;

FIG. 4 shows a diagram illustrating a reduction of pose uncertainty by combining two different measurements, according to embodiments;

FIG. 5 shows a flow diagram of a method of placing road objects on a map, using sensor information, according to embodiments; and

FIG. 6 shows a diagram of grouped map positions of road objects on a map, from a sequence of images, according to embodiments;

FIGS. 7A and 7B show diagrams of pose graphs respectively before and after optimization, according to embodiments;

FIGS. 8A and 8B show diagrams of pose graphs respectively before and after optimization, according to other embodiments; and

FIG. 9 shows a block diagram of a server in the system of [FIG. 1].

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

The embodiments described in the context of one of the devices or methods are analogously valid for the other devices or methods. Similarly, the embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of the various embodiments, the articles “a”, “an” and “the” as used with regard to a feature or element include a reference to one or more of the features or elements.

As used herein, the term “and/or” includes any and all combinations of one or more of the associated listed items.

In the following, the embodiments will be described in detail.

An e-hailing app, typically used on a smartphone, allows its user to hail a taxi or also a private driver through his or her smartphone for a trip.

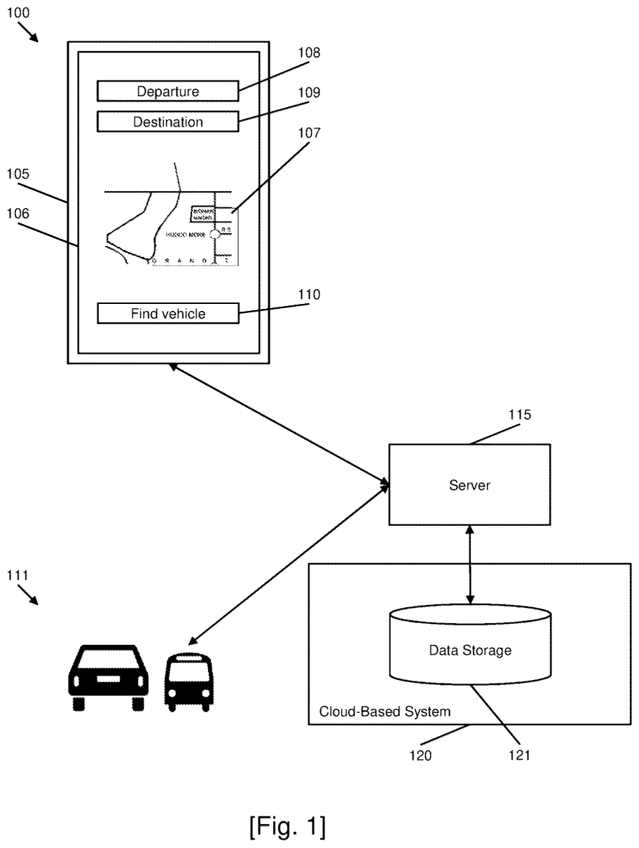

FIG. 1 shows a diagram of a system 100 for placing road objects on a map, using sensor information, according to embodiments.

Referring to FIG. 1, the system 100 includes a smartphone 105, registered vehicles 111, a server 115 and a cloud-based system 120.

The smartphone 105 includes a screen showing a graphical user interface (GUI) 106 of the e-hailing app that the user of the smartphone 105 previously installed on his or her smartphone 105 and opened (started) to e-hail a ride (taxi or private driver).

The GUI 106 includes a map 107 of a vicinity of a position of the user, which the app may determine based on, e.g., a GPS-based location service. Also, the GUI 106 includes a box for a point of departure 108, which may be set to a current location of the user that is obtained from the location service, and includes a box for a destination 109, which the user may touch to enter the destination, e.g., opening a list of possible destinations. There may further be a menu (not shown) allowing the user to select various options, e.g., how to pay (cash, credit card, credit balance of an e-hailing service). When the user selects the destination and makes any necessary option selections, he or she touches a “find vehicle” button 110 to initiate searching of a suitable vehicle.

For the above, the e-hailing app communicates with the server 115 of the e-hailing service via a radio connection. The server 115 may consult a memory of the server 115 or a data storage 121 including information of current locations of the registered vehicles 111, of when they are expected to be free, of traffic jams, etc. From this, a processor of the server 115 selects the most suitable vehicle (if available, e.g., if a transport request may be fulfilled) and provides an estimate of time when a driver will be there to pick up the user, a price of a ride and how long it will take to get to the destination. The server 115 communicates this back to the smartphone 105, and the smartphone 105 displays this information on the GUI 106. The user may then accept (book) by touching a corresponding button. If the user accepts, the server 115 informs a selected one among the vehicles 111 (or, equivalently, its driver), e.g., a vehicle the server 115 allocated for fulfilling the transport request.

It should be noted while the server 115 is described as a single server, its functionality (e.g., for providing the e-hailing service for a whole city) may in practical application be provided by an arrangement of multiple server computers (e.g., implementing a cloud service). Accordingly, functionalities described in the following provided by the server 115 may be understood to be provided by an arrangement of servers or server computers.

The data storage 121 may, for example, be part of the cloud-based system 120 provided by a cloud storage provider to store and access data, which it may use for taking decisions, such as information of locations of passengers and the vehicles 111, their history (earlier bookings and routes taken), etc.

The server 115 together with the vehicles 111 provide the e-hailing service, and form a transport system. It should be noted that while the example of [FIG. 1] relates to the e-hailing service in which persons are transported, a transport service for transporting items like fresh food and parcels may similarly be provided.

Embodiments described herein include methods and devices for achieving high placement accuracy of road objects on a map (e.g., the map 107) with a relatively medium amount of data that is collected by low cost devices and with a relatively medium processing power. Instead of relying on finding correspondences of abstract visual features for refining camera poses and a 3D structure of a scene like in SFM (which requires dense imagery collection and long processing times), the methods include identifying static road objects across multiple images, and by leveraging a constraint that the static road objects should have unique positions, refining an error of a camera and a final pose of the static random objects while solving an optimization problem.

The placing of road objects on a map using two or more low accuracy measurement sensors can achieve accurate results. For example, a weight of a person may be measured using two low-accuracy scales as follows.

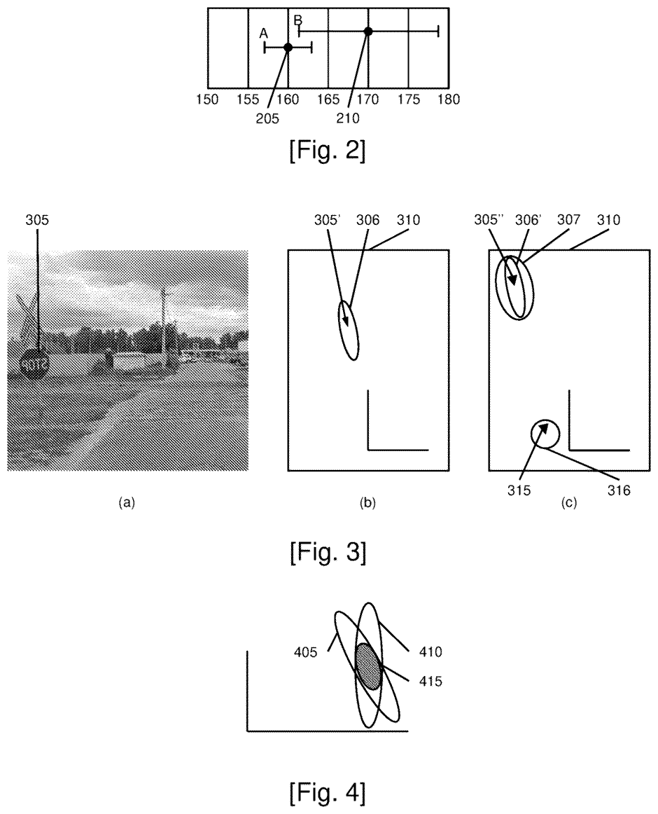

FIG. 2 shows a diagram illustrating a reduction of uncertainty by overlapping independent measurements 205 and 210.

Referring to [FIG. 2], a scale A has an error of ±3 lbs, and a scale B has an error that is 3 times larger, ±9 lbs. An overlap of the scales A and B includes an only possible true weight. This overlap is smaller than the error in the scale A or B alone.

Therefore, every image including a road object to be geolocated is treated as an individual measurement of a location of the road object. After computing an error of each individual measurement, a final accuracy of the location can be increased by considering the computed error of each individual measurement. Error aggregation may be represented as a pose-graph-optimization (PGO) problem.

FIG. 3 shows a diagram illustrating a propagation of errors through different stages of placing a road object 305 on a map 310, according to embodiments.

Placement of the road object 305 (e.g., a stop sign) on the map 310 may include the following steps. First, one or more road objects (e.g., traffic signs), including the road object 305, are identified in an image (a), using an object detector (e.g., a point-of-interest (POI) detector). Second, positions of the detected road objects relative to a camera are estimated, using deep learning (DL) depth estimation or by computing a distance between the camera and the road object using physical parameters of the camera and physical sizes of the road objects. Third, an orientation and a position of the camera are found. Fourth, geolocations of the road objects are computed by composing information that is gathered from the above three operations.

There may be errors in each of the above four operations. For example, a pose of a road object relative to the camera may have errors caused by an inaccurately-determined physical size of the road object and/or the inaccurately-determined intrinsic parameters of the camera that are needed to compute depth, and/or errors from computing an orientation of the road object. The orientation of the camera may also not be exact, which may directly impact a final position of the road object on the map. The error introduced may be directly proportional with a distance between the road object and the camera. A GPS position of the camera might be off (e.g., by a few meters) as well.

Referring to [FIG. 3], in portion (b), an ellipse 306 around a road object 305′ on the map 310 represents an uncertainty (e.g., a Gaussian distribution) in position, and a width of a pointer representing the road object 305′ represents an uncertainty (e.g., a Gaussian distribution) in orientation. In portion (c), ellipses 306′ and 307 around a road object 305″ on the map 310 represents an uncertainty (e.g., a Gaussian distribution) in position, a width of a pointer representing the road object 305″ represents an uncertainty (e.g., a Gaussian distribution) in orientation, an ellipse 316 around a camera 315 on the map 310 represents an uncertainty (e.g., a Gaussian distribution) in position, and a width of a pointer representing the camera 315 represents an uncertainty (e.g., a Gaussian distribution) in orientation.

Thus, the portions (b) and (c) may represent best guesses of where the road object 305′ or 305″ should be and represent how much one may be sure about such predictions. These estimations may be more powerful if more than one image is used as follows.

FIG. 4 shows a diagram illustrating a reduction of pose uncertainty by combining two different measurements 405 and 410, according to embodiments.

Referring to [FIG. 4], when the same road object is captured in two different images, the two different measurements 405 and 410 (e.g., geolocations) of that road object may be determined. More often than not, an actual geolocation 415 is somewhere between the two different measurements 405 and 410. In mathematics, this concept is formalized as expected value. Thus, with the two relatively inaccurate measurements 405 and 410, a more accurate result may be deduced. Therefore, it may not matter how poor a measurement precision is as long as a maximum error (a boundary) of the measurement precision is known and there are many measurements.

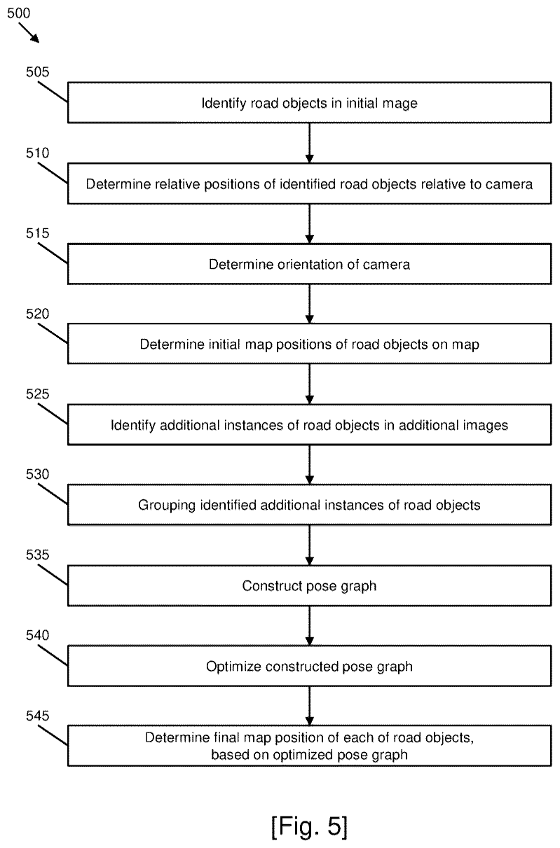

FIG. 5 shows a flow diagram of a method 500 of placing road objects on a map, using sensor information, according to embodiments.

Referring to [FIG. 5], in operation 505, the method 500 includes identifying a plurality of the road objects (e.g., traffic signs) in an initial image, using an object detector (e.g., a POI detector). The identified road objects may be referred to as “sensor information,” which may include noisy and/or uncertain information.

In operation 510, the method 500 includes determining relative positions of the identified road objects relative to a camera, using DL depth estimation or by computing distances between physical sizes of the road objects and physical properties of the camera. The determined relative positions may be referred to as “sensor information,” which may include noisy and/or uncertain information.

In operation 515, the method 500 includes determining an orientation of the camera. How the initial image is oriented in the world needs to be known. The determined orientation may be referred to as “sensor information,” which may include noisy and/or uncertain information.

In operation 520, the method 500 includes determining initial map positions of the road objects on a map, based on a position (e.g., GPS-based) of the camera, the determined orientation of the camera and the determined relative positions of the road objects relative to the camera. The position of the camera may be referred to as “sensor information,” which may include noisy and/or uncertain information.

In operation 525, the method 500 includes identifying additional instances of the same road objects in one or more additional images sequential to the initial image, using sign tracking or POI tracking.

In operation 530, the method 500 includes grouping the identified additional instances of the same road objects respectively into panels or pillars corresponding to the determined initial map positions (sign grouping).

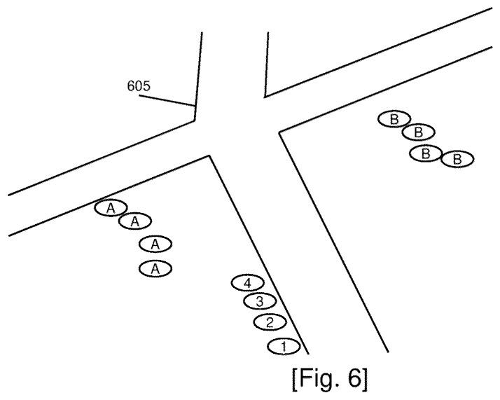

FIG. 6 shows a diagram of grouped map positions of road objects A and B on a map, from a sequence of images 1 to 4, according to embodiments.

Referring to [FIG. 6], in detail, ellipses 1 to 4 represent the sequence of images and respective positions of a camera. Ellipses A represent the grouped map positions of the road object A from the sequence of images 1 to 4, and ellipses B represent the grouped map positions of the road object B from the sequence of images 1 to 4. All of the ellipses 1 to 4, A and B also represent errors or uncertainties of their respective positions. Item 605 represents a road on the map.

The different map positions corresponding to the same object A or B are spread. This effect is produced by errors in measuring distances between the object A or B and the camera, a position of the camera and an orientation of the camera.

Referring again to [FIG. 5], in operation 535, the method 500 includes constructing a pose graph, based on the grouped map positions of the road objects (e.g., the panels, pillars or constraints of the road objects) and positions and orientations of the camera capturing the sequence of images, respectively.

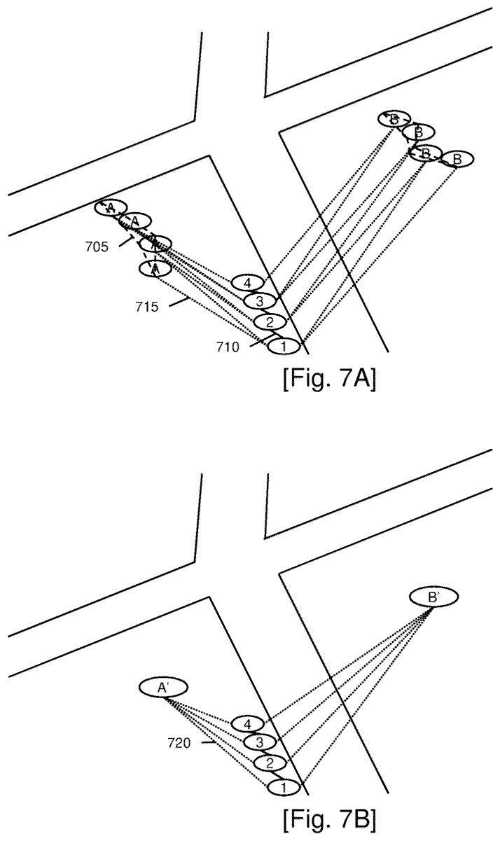

In operation 540, the method 500 includes optimizing the constructed pose graph.

[FIGS. 7A and 7B] show diagrams of pose graphs respectively before and after optimization, according to embodiments.

Referring to [FIG. 7A], in the pose graph, each node (e.g., each of the ellipses 1 to 4, A and B) represents a measurement, and each edge between nodes represents a constraint or a relative pose that is computed in the operations 505-530. Instances of the same road object that are detected in multiple images are set to have a relative pose of identity, therefore adding a constraint that those have a unique final position. A similar constraint is added for traffic signs that are identified to be vertically stacked on the same pillar.

In detail, dashed edges 705 are constraints that are not flexible at all. For each of the dashed edges 705, a relative pose between two nodes of the same road object should be 0. Lined edges 710 represent camera poses of a camera, and dashed edges 715 represent object poses respectively of the road objects relative to the camera. Both the lined edges 710 and the dashed edges 715 can be adjusted. Because the edges 705, 710 and 715 represent poses, which may be harder to visualize, the edges 705, 710 and 715 can be thought of as lines in an SE (3) space.

Referring to [FIG. 7B], the constructed pose graph is optimized by moving around end nodes of the lined edges 710 and the dashed edges 715 in their uncertainty areas such that lengths of the dashed edges 705 are minimized to construct refined dashed edges 720 representing object poses respectively of the road objects A and B relative to the camera. The more uncertainty there is in a pose (e.g., the larger an ellipse is), the more flexible/adjustable an edge 710 or 715 is. The uncertainty in each object pose is reduced after the graph optimization process. For example, in [FIG. 7B], the ellipses A are overlapped and reduced to a single ellipse A′ (e.g., a standard deviation of Gaussian distributions representing uncertainty), and the ellipses B are overlapped and reduced to a single ellipse B′ (e.g., a standard deviation of Gaussian distributions representing uncertainty).

Referring again to [FIG. 5], in operation 545, the method 500 includes determining a final map position of each of the road objects, based on the optimized pose graph. The determining the final map position may include adding the refined object poses that are obtained from the optimized pose graph.

Referring again to [FIG. 7B], a final map position A′ or B′ of each of the road objects A and B are determined, by adding the refined object poses of the optimized pose graph.

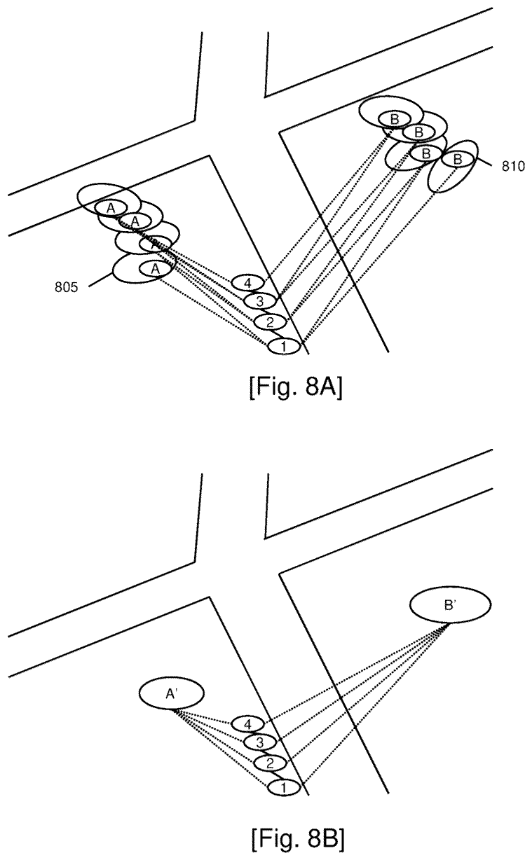

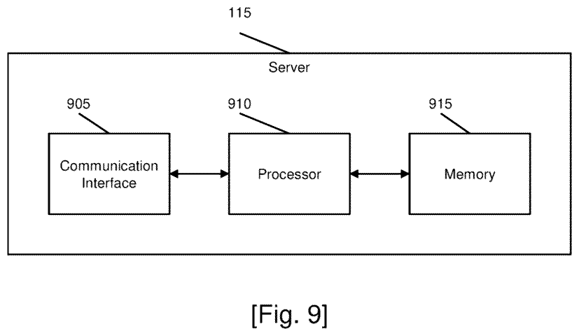

Thus, when the multiple images are leveraged in the above-described method 500, the operations 505-520 may be performed for each image independently to come up with initial estimates for poses of road objects observed in each image. These initial estimates are then refined using information from multiple sources in the operations 525-545. During the method 500, not only the poses of the road objects but also estimations of poses of images (the camera) are refined, which results in a better placement of other road objects visible in the camera that were not part of the initially-constructed pose graph.

[FIGS. 8A and 8B] show diagrams of pose graphs respectively before and after optimization, according to other embodiments.

Referring to [FIG. 8A], additional ellipses 805 respectively surround nodes representing measurements of road objects A and B, and represent standard deviations in positional uncertainties of the measurements. However, referring to [FIG. 8B], through the optimization, final map positions A′ and B′ of the road objects A and B may still be determined, in which the positional uncertainties in each object pose are reduced.

FIG. 9 shows a block diagram of the server 115 in the system 100 of [FIG. 1].

Referring to [FIG. 9], the server 115 may be a server computer that includes a communication interface 905, a processor 910 and a memory 915.

The communication interface 905 may serve as a hardware and/or software interface that may, for example, transfer commands and/or data between a user and/or external devices and other components of the server 115. The communication interface 905 may further set up communication between the server 115 and the external devices, such as the smartphone 105 of [FIG. 1]. The communication interface 905 may be connected with a network through wireless or wired communication architecture to communicate with the external devices. The communication interface 905 may be a wired or wireless transceiver or any other component for transmitting and receiving signals.

The processor 910 may include one or more of a CPU, a graphics processor unit (GPU), an accelerated processing unit (APU), a many integrated core (MIC), a field-programmable gate array (FPGA), and/or a digital signal processor (DSP). The processor 910 may be a general-purpose controller that performs control of any one or any combination of the other components of the server 115, and/or performs an operation or data processing relating to communication. The processor 910 may execute one or more programs stored in the memory 915.

The memory 915 may include a volatile and/or non-volatile memory. The memory 915 stores information, such as one or more of commands, data, programs (one or more instructions), applications, etc., which are related to at least one other component of the server 115 and for driving and controlling the server 115. For example, commands and/or data may formulate an operating system (OS). Information stored in the memory 915 may be executed by the processor 910. The memory 915 may further store information that is executed by the processor 910 to perform functions and operations described with respect to [FIGS. 1-8B] above.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g., a microprocessor. A “circuit” may also be software being implemented or executed by a processor, e.g., any kind of computer program, e.g., a computer program using a virtual machine code. Any other kind of implementation of the respective functions that are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are therefore intended to be embraced.

1. A method of placing road objects on a map, using sensor information, the method comprising:
determining initial map positions of a road object on the map, the initial map positions respectively corresponding to images of the road object that are captured by a camera at different camera positions on the map:
constructing a pose graph in which one or more pairs of the initial map positions are respectively connected by first edges, one or more pairs of the different camera positions are respectively connected by second edges, and the initial map positions are respectively connected to the different camera positions by third edges:
optimizing the constructed pose graph by adjusting the initial map positions, the different camera positions, the second edges and the third edges so that lengths of the first edges are minimized; and
determining a final map position of the road object, based on the optimized pose graph.

2. The method of claim 1, wherein the initial map positions are represented on the map as areas indicating uncertainties of the initial map positions.

3. The method of claim 1, wherein the determining the final map position of the road object comprises adding the adjusted initial map positions to determine the final map position respectively connected to the different camera positions by the adjusted third edges.

4. The method of claim 1, wherein the final map position is represented on the map as an area indicating an uncertainty of the final map position.

5. The method of claim 1, further comprising identifying the road object in each of the images, using an object detector.

6. The method of claim 5, further comprising determining relative positions of the identified road object relative to the camera in the images, respectively.

7. The method of claim 6, wherein the relative positions of the identified road object relative to the camera are determined using a deep learning depth estimation.

8. The method of claim 6, wherein the relative positions of the identified road object relative to the camera are determined by determining distances between a physical size of the road object and physical properties of the camera, respectively.

9. The method of claim 6, further comprising determining an orientation of the camera.

10. The method of claim 9, wherein the initial map positions of the road object are determined based on a position of the camera, the determined orientation of the camera, and the determined relative positions of the identified road object relative to the camera.

11. A server comprising:
at least one memory storing instructions; and
at least one processor configured to execute the stored instructions to:
determine initial map positions of a road object on the map, the initial map positions respectively corresponding to images of the road object that are captured by a camera at different camera positions on the map:
construct a pose graph in which one or more pairs of the initial map positions are respectively connected by first edges, one or more pairs of the different camera positions are respectively connected by second edges, and the initial map positions are respectively connected to the different camera positions by third edges:
optimize the constructed pose graph by adjusting the initial map positions, the different camera positions, the second edges and the third edges so that lengths of the first edges are minimized; and
determine a final map position of the road object, based on the optimized pose graph.

12. The server of claim 11, wherein the initial map positions are represented on the map as areas indicating uncertainties of the initial map positions.

13. The server of claim 11, wherein the at least one processor is further configured to execute the stored instructions to add the adjusted initial map positions to determine the final map position respectively connected to the different camera positions by the adjusted third edges.

14. The server of claim 11, wherein the final map position is represented on the map as an area indicating an uncertainty of the final map position.

15. The server of claim 11, wherein the at least one processor is further configured to execute the stored instructions to identify the road object in each of the images, using an object detector.

16. The server of claim 15, wherein the at least one processor is further configured to execute the stored instructions to determine relative positions of the identified road object relative to the camera in the images, respectively.

17. The server of claim 16, wherein the at least one processor is further configured to execute the stored instructions to determine an orientation of the camera.

18. The server of claim 17, wherein the initial map positions of the road object are determined based on a position of the camera, the determined orientation of the camera, and the determined relative positions of the identified road object relative to the camera.

19. A computer program element comprising program instructions, which, when executed by one or more processors, cause the one or more processors to perform the method of claim 1.

20. A computer-readable medium comprising program instructions, which, when executed by one or more processors, cause the one or more processors to perform the method of claim 1.
